(19) United States
(12) Patent Application Publication
(10) Pub. No.: US 2026/0016809 A1
(43) Pub. Date: Jan. 15, 2026

(54) Digital Humanoid Robots with Dynamical Models for Robot Guidance and Control System Design

(71) Applicant: General Cybernation Group Inc., Rancho Cordova, CA (US)

(72) Inventors: George Shu-Xing Cheng, Folsom, CA (US); Andrew J. Chow, Sacramento, CA (US)

(73) Assignee: General Cybernation Group Inc., Rancho Cordova, CA (US)

(21) Appl. No.: 18/771,382

(22) Filed: Jul. 12, 2024

(51) Int. Cl. G05B 19/4097; B25J 9/16

(52) U.S. Cl. CPC G05B 19/4097; B25J 9/1671; G05B 2219/40515

(57) ABSTRACT

This patent discloses a computer system for humanoid robot control system design and implementation, featuring a digital humanoid robot with dynamical models and a set of single-input-single-output (SISO) and multi-input-multi-output (MIMO) controllers. The system comprises a main software program, a generative Al humanoid robot intelligence engine, a robot motion path planner module, and a control system simulation engine. It enables efficient design, testing, validation, and implementation of robot control systems, significantly reducing time to market. The system supports seamless upgrades to accommodate new designs and components, enhancing applications in industrial automation, healthcare, public safety, and more, aligning with the goals of the 4th Industrial Revolution.

### FIELD OF INVENTION

The subject of this patent relates to artificial intelligence, humanoid robots, dynamical models, and guidance and control of humanoid robots.

Riding the AI wave, humanoid robots are the next big thing that can provide huge benefits to our daily lives and revolutionize our world. Enabled by large language models and generative artificial intelligence (AI), humanoid robots could potentially mimic human behavior, respond to natural language commands, express emotions, and perform human-like tasks. However, AI is only the first half of the puzzle. The second half is connecting the robot to the physical world. A humanoid robot still needs to know how to walk, run, climb stairs, hold objects, move things around, and talk like a human. Smart sensors and controls are critical elements for humanoid robots to navigate and interact with the physical environment.

A humanoid robot is an advanced machine designed to resemble and mimic the human body's structure and functionality. These robots typically include the following key components:
Head: The head houses essential sensory equipment, such as cameras for vision, microphones for hearing, and advanced sensors for facial recognition and expression. It serves as the primary sensory hub of the robot.
Body: The central structure that supports and connects all other components. The body contains the main computational units, power supply, and additional sensors for balance and orientation.
Arms: A humanoid robot has two arms attached to the body. Each arm consists of an upper arm and a forearm connected by joints, allowing for a wide range of movements.
Hands: Attached to the ends of the arms, robotic hands are intricate components designed to replicate human hand movements and dexterity. Each hand typically features multiple joints and fingers, with actuators and sensors enabling precise control and manipulation of objects.
Legs: The robot has two legs connected to the lower part of the body. Each leg includes segments a thigh and lower leg connected by joints, providing stability and mobility.
Feet: Located at the end of each leg, the feet are crucial for balance and movement. They may contain sensors and actuators to help the robot walk, run, or stand.
Actuators: These are the mechanical components that drive movement in the robot's joints. Actuators can be electric motors or hydraulic systems enabling the robot to perform complex motions.
Sensors: Various sensors throughout the robot gather data about the environment and the robot. These include vision sensors, auditory sensors, tactile sensors, and position and movement sensors.
Guidance and Control System: It serves as the “brain” of the robot, consisting of computer microprocessors and software that process data from the sensors, execute control algorithms, and send commands to the actuators. It enables the robot to perform coordinated and complex tasks, from basic movements like walking and running to more advanced activities such as climbing stairs, avoiding obstacles, manipulating objects, and interacting with humans.
Power Supply: A compact, high-capacity battery system to power the robot, including a wireless battery charger for convenient recharging.
Communication System: A wireless communication system to send data to a remote operator or central database and receive commands.

Together, these components enable humanoid robots to perform a wide range of tasks, from simple movements to complex manipulations, closely emulating human actions and interactions.

The advancement of large language models (LLM) and generative artificial intelligence (Gen-AI) makes it feasible to train humanoid robots to perform certain tasks using videos and texts, allowing trained AI models to be integrated with the guidance and control system. However, humanoid robots face unique motion control challenges due to their complex biometric design and the need to maintain dynamic stability during locomotion and manipulation tasks. There are several layers in humanoid robot guidance and control. At the lowest layer, which is also the most difficult, it is a high-speed servo control problem with variations in motion, dynamic behavior, inertia, and friction. Sudden and large load changes can cause instability and failed motions. Traditional Proportional-Integral-Derivative (PID) control is not sufficient, and model-based control methods are too complicated and costly to implement.

A guidance and control system for a humanoid robot is a sophisticated mechanism that directs the robot's movements and actions in real-time. The guidance system involves determining the path and actions for the robot based on inputs from various sensors, such as video cameras and motion sensors. This includes processing environmental data to navigate obstacles, adjust motion paths, and execute specific tasks. The control system translates these guidance decisions into commands for the actuators, ensuring smooth and accurate movements of the head, legs, arms, and hands of the robot. Together, this system enables the robot to perform complex tasks autonomously and efficiently. More specifically, a guidance command typically consists of a set of setpoint trajectories for position, velocity, and acceleration of a variable of a robot joint. The control system is responsible for producing control signals to manipulate the actuators so that the robot joint moves and tracks these setpoints.

If a robot has a limited number of joints to perform a well-defined task in a fixed environment, the control system can be designed using model-based control methods and PID controllers. For instance, consider a robot arm in a manufacturing plant that performs the following sequence of actions: (i) starting from position 1; (ii) moving to position 2 and picking up an object; (iii) rotating the arm to position 3, (iv) releasing the object; and (v) moving back to position 1. Its control system design is relatively simple.

A general-purpose humanoid robot has many more joints, most of which have 3 degrees of freedom. The robot needs to perform undefined tasks in an unknown environment. The generative AI has the potential to assist in developing a robot guidance system using large-language-model (LLM) training. However, the control system remains the most challenging obstacle in developing such a humanoid robot. Since it must be a deterministic system with 100% repeatability, LLM-based generative AI, which is a statistical-based approach, is not suitable. There is an urgent need in the market to develop methods and tools for humanoid robot control system design.

In this patent, we disclose a computer system that includes a digital humanoid robot with dynamical models as well as a set of single-input-single-output (SISO) controllers and multi-input-multi-output (MIMO) controllers for robot control system design and implementation. The dynamical behavior of each joint of the humanoid robot is represented by dynamical equations in Laplace transfer functions with a set of parameters that can vary significantly to simulate dynamic changes, varying operating conditions, and other uncertainties. The digital humanoid robot can be used to simulate the behavior of a real humanoid robot in complex environments and operating conditions, facilitating the design, testing, and validation of a robot guidance and control system before or during the construction of a physical humanoid robot.

In the accompanying drawings:

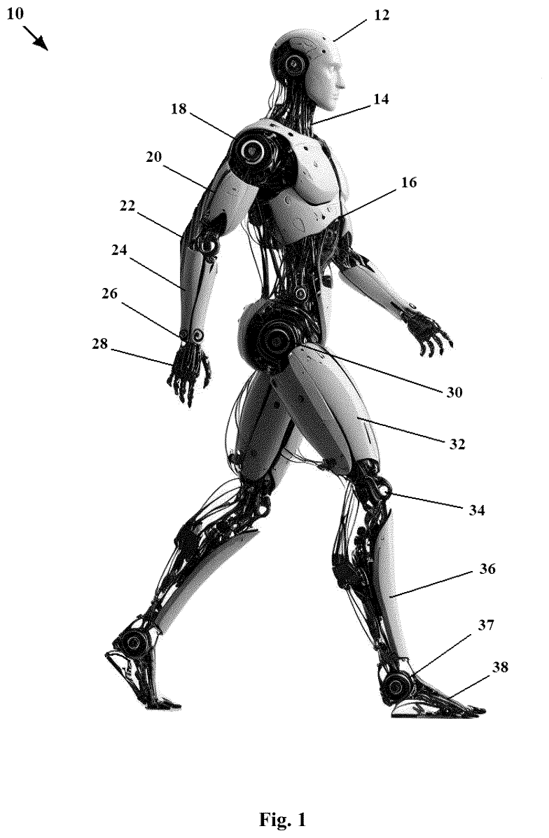

FIG. 1 is a perspective view of a humanoid robot with all key components and joints, according to an embodiment of this invention.

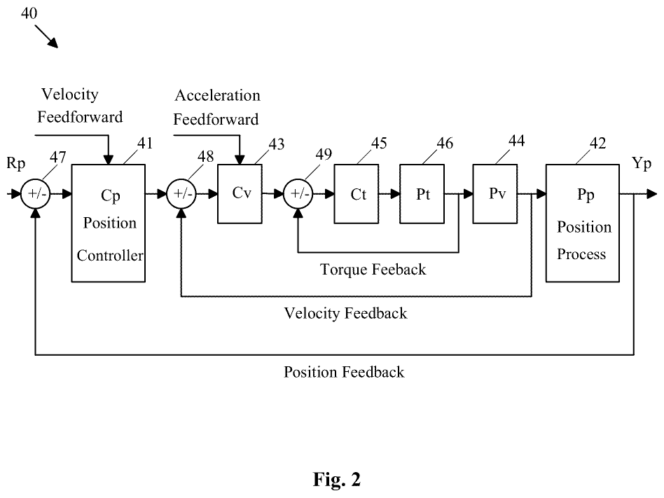

FIG. 2 is a block diagram of single-input-single-output (SISO) servo motion control system of a robotic joint, according to an embodiment of this invention.

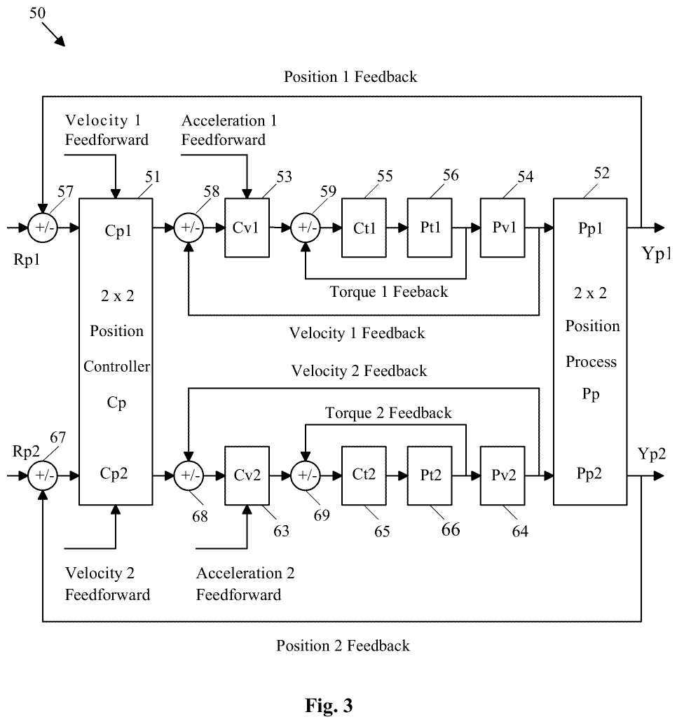

FIG. 3 is a block diagram of 2-input-2-output (2×2) servo motion control system of two coupled variables of a robot joint, according to an embodiment of this invention.

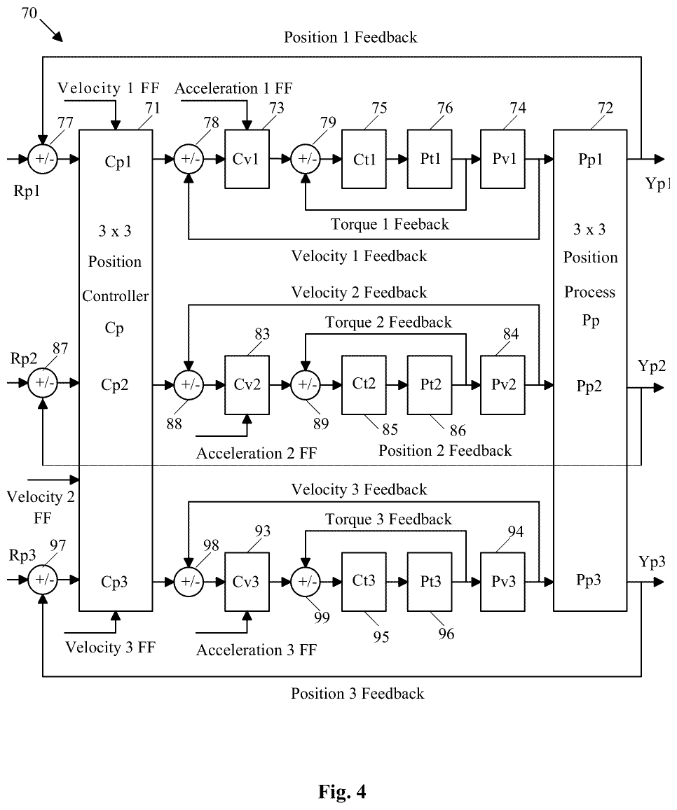

FIG. 4 is a block diagram of 3-input-3-output (3×3) servo motion control system of three coupled variables of a robot joint, according to an embodiment of this invention.

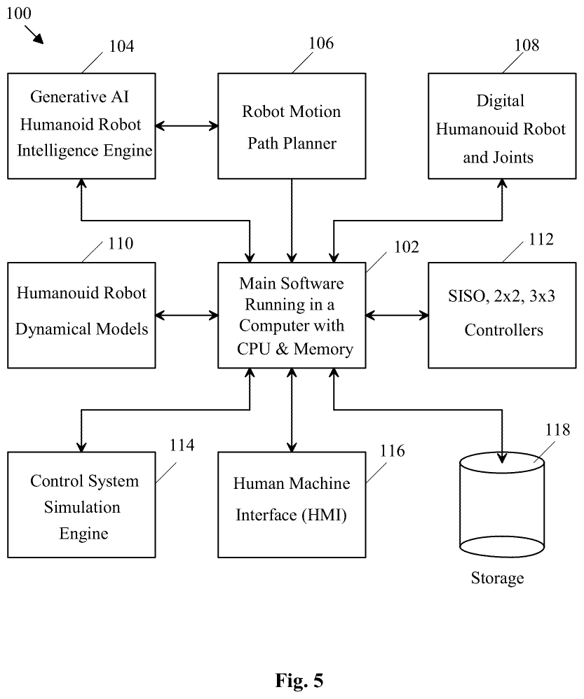

FIG. 5 is a block diagram of a computer system that includes a digital humanoid robot with dynamical models as well as a set of single-input-single-output (SISO) controllers and multi-input-multi-output (MIMO) controllers for robot control system design and implementation, according to an embodiment of this invention.

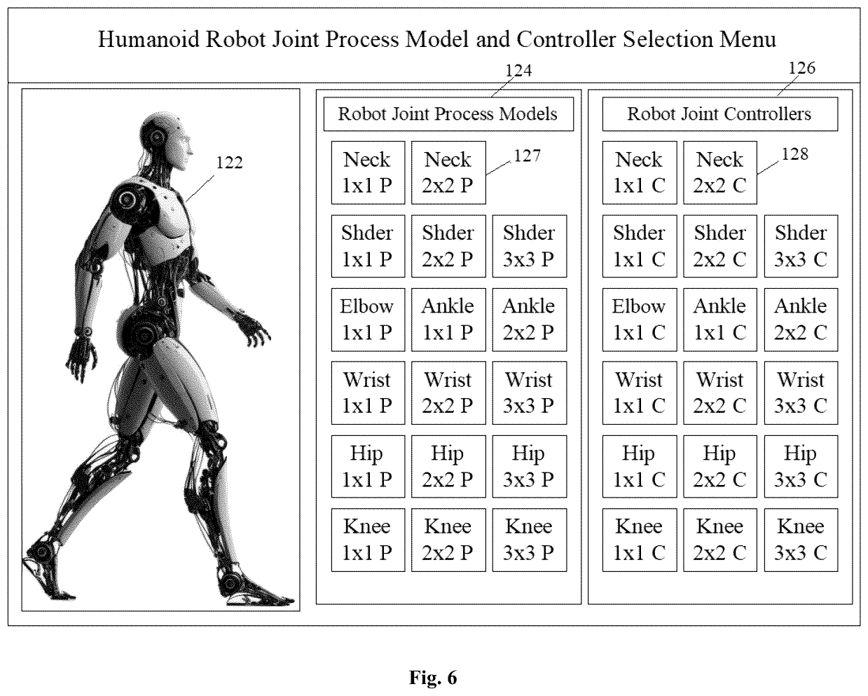

FIG. 6 is a perspective view of a computer HMI screen showing a Humanoid Robot Joint Process Model and Controller Selection Menu, according to an embodiment of this invention.

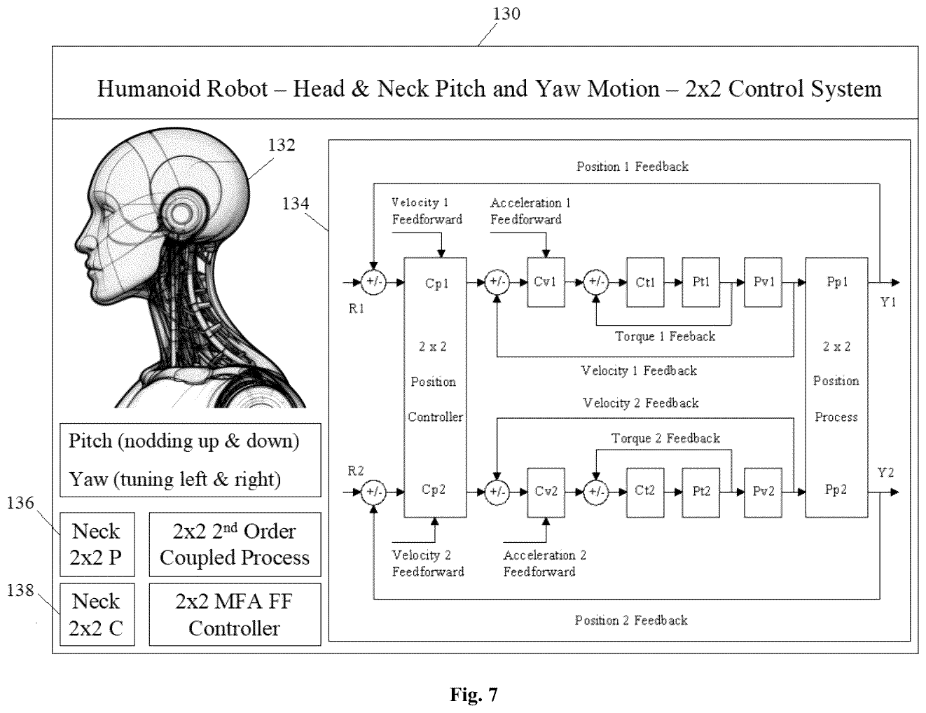

FIG. 7 is a perspective view of a computer HMI screen showing a Humanoid Robot—Head & Neck Pitch and Yaw Motion—2×2 Control System menu, according to an embodiment of this invention.

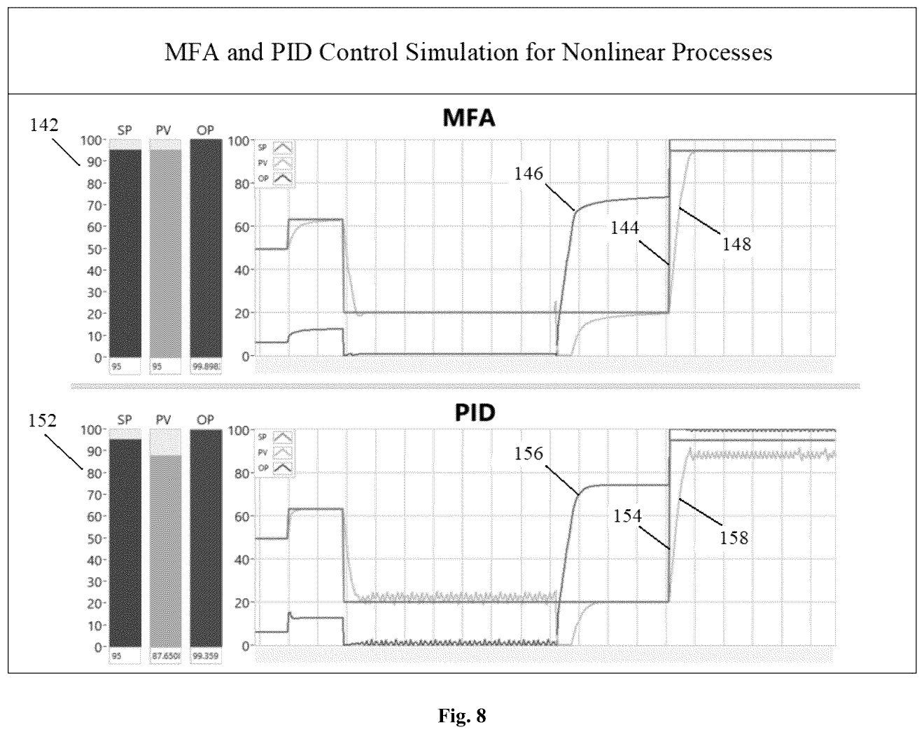

FIG. 8 is a perspective view of a computer HMI screen showing MFA and PID control simulation for nonlinear processes, according to an embodiment of this invention.

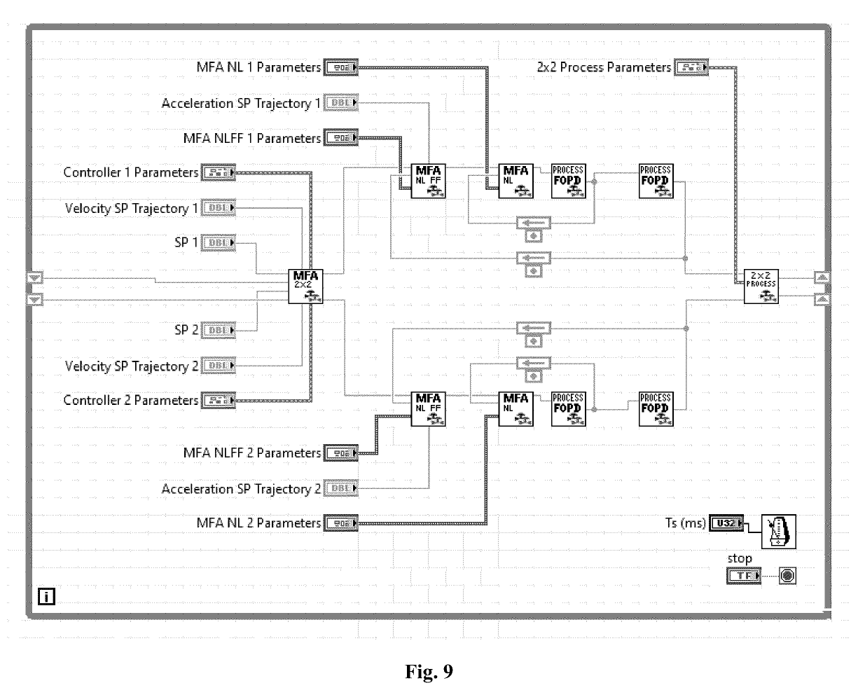

FIG. 9 is a computer screen showing the real implementation of a 2×2 MFA control system for controlling a 2×2 robot joint in the LabVIEW environment, according to an embodiment of this invention.

In this patent, the term “mechanism” is used to represent hardware, software, or any combination thereof. The term “process” is used to represent a physical system or process with inputs and outputs that have dynamic relationships. The term “AI” means artificial intelligence. The term “LLM” means large language model. The term “SLM” means small language model. The term “Gen-AI” means generative AI. The term “GPT” means generative pre-trained transformer. The term “transformer” means a form of artificial neural network model used in generative artificial intelligence. The term “humanoid robot” means a robot that looks and behaves like a human. The term “human-like robot” means a robot that looks and behaves like a human. The term “robot” or “robotic” means a machine resembling a human being, animal, or bird that is able to replicate certain movements and functions of a human being, animal, or bird, automatically. The term GPS means Global Positioning System that provides users with positioning, navigation, and timing (PNT) services. The term SISO means single-input-single-output. The term MIMO means multi-input-multi-output. The term MISO means multi-input-single-output. The term SIMO means single-input-multi-output. MFA control refers to Model-Free Adaptive control. PID control refers to Proportional-Integral-Derivative control. PI control refers to Proportional-Integral control. PD control refers to Proportional-Derivative control. P control refers to Proportional control. Controller refers to an automatic controller for physical process such as a robot joint. In this document, s is often used to represent the Laplace transform operator, Gp(S) is the process model in Laplace transfer function, and Gc(S) is the controller in Laplace transfer function.

Without losing generality, all numerical values or formulas given in this patent are examples. Other values or formulas can be used without departing from the spirit or scope of this invention. The description of specific embodiments herein is for demonstration purposes and in no way limits the scope of this disclosure to exclude other not specifically described embodiments of this invention.

### DESCRIPTION

### A. Humanoid Robot and Its Joints

FIG. 1 is a perspective front view of a humanoid robot with all key components and joints, according to an embodiment of this invention. The robot (10) comprises the following main components and joints:
Head (12): Contains sensors and cameras for vision and audio processing.
Neck Joint (14): Provides movement and flexibility for the head.
Torso (16): The central body structure housing the main control unit and power supply.
Shoulder Joints (18): Connects the arms to the torso and allows for a wide range of arm movements.
Upper Arms (20): Sections between the shoulder and elbow joints.
Elbow Joints (22): Allow for bending and extension of the arms.
Forearms (24): Sections between the elbow and wrist joints.
Wrist Joints (26): Provide rotation and flexibility for the hands.
Hands (28): Equipped with fingers for manipulation and grasping objects.
Hip Joints (30): Connects the legs to the torso and provides movement for walking and balancing.
Thighs (32): Sections between the hip and knee joints.
Knee Joints (34): Allow for bending and extension of the legs.
Lower Legs (36): Sections between the knee and ankle joints.
Ankle Joints (37): Provide movement and flexibility for the feet.
Feet (38): Support standing and walking, equipped with sensors for balance and terrain adaptation.

Humanoid robots face unique motion control challenges due to their complex biometric design and the need to maintain dynamic stability during locomotion and manipulation tasks. There are several layers in humanoid robot guidance and control. At the lowest layer, which is also the most difficult, it is a high-speed servo control problem with variations in motion, dynamic behavior, inertia, and friction. Sudden and large load changes can cause instability and failed motions. Traditional PID control is not sufficient and model-based control methods are too complicated and costly to implement. Examples of sudden and large load changes to humanoid robots are listed in Table 1.

TABLE 1

| | Robot | Sudden and Large Load Changes to |
|---|---|---|
| No. | Motion | a Humanoid Robot |
| 1 | Lifting Heavy | Lift a heavy object, the sudden increase in load |
| | Objects | can place significant stress on its joints and |
| | | actuators. |
| 2 | Pushing or | Pushing or pulling a heavy object, such as a cart |
| | Pulling | or a door, sudden changes in resistance or |
| | Objects | friction can result in abrupt load changes. |
| 3 | Interacting with | In dynamic environments, humanoid robots may |
| | Dynamic | encounter unexpected obstacles or changes in |
| | Environments | terrain, leading to sudden changes in the load |
| | | on their limbs and actuators. |
| 4 | Assisting | When assisting humans, robots must adapt to |
| | Humans | changes in the human's movements and |
| | | intentions, which can result in sudden load |
| | | changes. |
| 5 | Performing | When jumping or leaping, robots may need rapid |
| | Agile | acceleration and deceleration, leading to sudden |
| | Movements | changes in load on their joints and actuators. |

### B. Dynamical Models for Humanoid Robots

Dynamical models for robots today are primarily represented in the time domain using state-space equations. While state-space models can be difficult to understand and implement, they offer several advantages over Laplace transfer function models.
1. State-space models can handle multiple-input-multiple-output (MIMO) systems, whereas transfer functions are limited to single-input-single-output (SISO) systems. Robots often have multiple actuators and sensors, making MIMO modeling essential.
2. State-space models can represent the internal states of the system, providing insights into the system's behavior and allowing direct control of those states. Transfer functions can only model the input-output relationship.
3. State-space models can more easily incorporate nonlinearities and time-varying parameters compared to transfer functions, which assume linearity and time-invariance. Robots exhibit nonlinear dynamics due to factors such as friction and backlash.
4. State estimators, such as the Kalman filter, which are crucial for state feedback control in robotics, are derived from state-space models.
5. Advanced control techniques, such as LQR (linear quadratic regulator) and LQG (linear quadratic Gaussian) control, are formulated directly in the state-space domain.

Despite these advantages, state-space models are very complicated, difficult to understand and implement. They also have the following major disadvantages:
1. They are difficult to manage when dealing with time delays.
2. It is extremely difficult to program state-space based models and controllers, as computer programming is based on difference equations. There is no effective method to convert complex state-space and time-domain differential equations into difference equations.
3. Practically, when using the Z-transform to convert time-domain equations to difference equations for programming, it remains an approximation method that loses the detailed representation of the dynamical behavior. Therefore, developing such complicated dynamical models using state-space equations is not a good approach.

To summarize, these challenges may explain why there are no modeling and simulation software tools available on the market for humanoid robots that have built-in robotic models for the main joints.

The Laplace transform is a mathematical tool used to analyze and describe dynamical systems. It transforms complex time-domain functions into simpler s-domain representations, making it easier to solve differential equations by converting them into algebraic equations. Then the algebraic formulas and tools can be used to analyze and solve dynamical system problems.

Laplace transfer functions can be used to represent the input-output relationship of dynamical systems with time delays. Although standard Laplace transfer functions can only describe linear time-invariant (LTI) systems, their parameters, such as gain, time constant, and delay time, can be intentionally changed to simulate nonlinear and time-varying systems. In addition, a multi-input-multi-output (MIMO) process model can be developed using a set of SISO process models. This approach is practically useful because it simplifies the design, analysis, and implementation of control systems for humanoid robots.

Based on this approach, we have developed a method to model humanoid robots using Laplace transfer functions. In this patent, we present a set of simplified dynamical models that can represent the dynamical behavior of the main joints of a humanoid robot in Laplace transfer functions. These models are the main components of the digital humanoid robot in this invention.

### C. Single-Input-Single-Output (SISO) Dynamical Models of Robot Joints

A joint of a humanoid robot typically comprises (i) a servo motor such as a frameless torque motor, (ii) a linear or rotational actuator, (iii) mechanical components such as a harmonic gear drive, (iv) load, and (v) sensors. Each component has a dynamical input-output relationship. When using an accurate model to include the dynamics of all components in the chain, it results in a high-order dynamical equation in either the time-domain or Laplace transfer function.

To simplify the problem, it is reasonable to use a low-order dynamical model to approximate the high-order process. We can assume that if the controller can effectively deal with the dynamical behavior changes and other uncertainties, a simplified low-order process model is sufficient in robot control applications. A set of low-order process models is presented below, which can be used for modeling and simulating the dynamical behavior, movements, and coupling effects of robotic joints.

### First-Order-Plus-Delay Process Model

The representation of many dynamical systems or processes can be simplified by using a First-Order-Plus-Delay (FOPD) model in Laplace transfer function as follows:

$${G}_{p} ( s ) = \frac{K {e}^{- τ S}}{{T}_{c} s + 1} , \qquad ( 1 )$$

where Gp(S) is the transfer function of a dynamical process, s is the Laplace transform operator, K is the static gain, T_{c} is the time constant, and τ is the delay time. K is a constant, T_{c} and τ are in seconds. In this patent, a process refers to a dynamical process or system with input and output relationships to be modeled or controlled. When τ=0, it becomes a first-order process which is useful to model a sensor or actuator of the robot.

### Second-Order Process Model

The representation of many dynamical systems or processes can also be modeled using a Second-Order model in Laplace transfer function as follows:

$${G}_{p} ( s ) = \frac{{K}_{2} {s}^{2} + {K}_{1} s + 1}{{T}_{2} {s}^{2} + {T}_{1} s + 1} , \qquad ( 2 )$$

where K₂, K₁, T₂, T₁ are constants. When K₁=0, and K₂=0, it becomes

$${G}_{p} ( s ) = \frac{1}{{T}_{2} {s}^{2} + {T}_{1} s + 1} , \qquad ( 3 )$$

Equation (3) is often used to represent servo motors.

### Servo Motor Dynamical Model

The dynamical behavior of a servo-motor used in robotic joint control can be represented by using the following second-order process model:

$${G}_{p} ( s ) = \frac{Θ ( s )}{V ( s )} = \frac{K}{J {s}^{2} + Bs + 1} \qquad ( 4 )$$

where Θ(s) is the angular position in Laplace domain, V(s) is the input voltage in Laplace domain, K is the motor constant, J is the moment of inertia, and D is the damping coefficient.

### D. Multi-Input-Multi-Output (MIMO) Dynamical Models of Robot Joints

We may use single-input-single-output (SISO) process models to represent robot joints. In practice, things are often not that simple. If a robot joint has 2 or 3 degrees of freedom, each requiring a servo motor and actuator, the joint becomes a multi-input-multi-output (MIMO) process due to the coupling effects among variables of the joint.

A humanoid robot is designed to mimic the motion of a human. Table 2 lists the degree of freedom (DOF) of the main joints of a human body, their related motions, and example of dynamical model design. If 2 motions are highly coupled, we will use a 2×2 dynamical model to represent it. For instance, Pitch and Yaw of the neck. Since there are different ways to design a hand with a varying number of fingers for humanoid robots, it is not included in this section.

TABLE 2

| | | | | Model Design |
|---|---|---|---|---|
| No. | Joint | DOF | Motion | Example |
| 1 | Head and | 3 | Pitch (nodding up and down) | Pitch - Yaw: 2 × 2 |
| | Neck | | Yaw (turning left and right) | Roll, 1 × 1 |
| | | | Roll (tilting side to side) | |
| 2 | Shoulder | 3 × 2 | Flexion and Extension (raising and lowering the | Flexion- |
| | | | arm in front of and behind the body) | Abduction: |
| | | | Abduction and Adduction (raising and lowering the | 2 × 2 |
| | | | arm away from and towards the body's midline) | Rotation: 1 × 1 |
| | | | Internal and External Rotation (rotating the arm | |
| | | | inward and outward) | |
| 3 | Elbow | 2 × 2 | Flexion and Extension (bending and straightening | Flexion: 1 × 1 |
| | | | the arm) | Pronation: 1 × 1 |
| | | | Pronation and Supination (rotating the forearm so | |
| | | | the palm faces down or up) | |
| 4 | Wrist | 3 × 2 | Flexion and Extension (bending forward and | Flexion-Radial: |
| | | | backward) | 2 × 2 |
| | | | Radial and Ulnar Deviation (tilting towards the | Pronation: 1 × 1 |
| | | | thumb and towards the little finger) | |
| | | | Pronation and Supination (rotating the hand palm | |
| | | | up and palm down) | |
| 5 | Hip | 3 × 2 | Flexion and Extension (moving the thigh forward | Flexion - |
| | | | and backward) | Abduction: |
| | | | Abduction and Adduction (moving the thigh away | 2 × 2 |
| | | | from and towards the body's midline) | Rotation: 1 × 1 |
| | | | Internal and External Rotation (rotating the thigh | |
| | | | inward and outward) | |
| 6 | Knee | 3 × 2 | Flexion and Extension (bending and straightening) | Flexion: 1 × 1 |
| | | | Rotation (internal and external rotation when the | Rotation: 1 × 1 |
| | | | knee is bent) | Varus: 1 × 1 |
| | | | Varus and Valgus (side-to-side movement, which is | |
| | | | very limited) | |
| 7 | Ankle | 2 × 2 | Dorsiflexion and Plantarflexion (bending the foot | Dorsiflexion - |
| | | | upward and downward) | Inversion: 2 × 2 |
| | | | Inversion and Eversion (tilting the sole of the foot | |
| | | | towards the midline of the body and away from it) | |
| 8 | Foot | 1 × 2 | Dorsiflexion and Plantarflexion (bending the foot | Dorsiflexion and |
| | | | palm). | Plantarflexion: |
| | | | | 1 × 1 |
| | Total | 37 | | |

To understand the coupling effects between two movements, we use the wrist as an example. There is a coupling effect between flexion and radial deviation due to the following reasons:
Interconnected Actuators: In the wrist, actuators controlling flexion (bending forward and backward) and radial deviation (tilting towards the thumb and little finger) are often physically close. This proximity means that movement in one axis can influence the other due to the mechanical connections and forces transmitted through the joint.
Shared Structural Elements: The wrist joint structure itself can introduce coupling. For example, if the actuator for flexion is mounted on the same structure that supports the actuator for radial deviation, movements in flexion can affect the positioning and function of the radial deviation actuator.
Dynamic Coupling: There is coupling in inertia and momentum. The wrist's rapid movements in one axis can generate forces that affect the other axis. For example, a quick flexion movement can produce momentum that impacts radial deviation, requiring compensation to maintain the desired orientation.
Gyroscopic Effects: Rotational movements of the wrist can generate gyroscopic forces that couple the flexion and radial deviation movements. These forces need to be managed for precise control.

To manage and mitigate the coupling effects between flexion and radial deviation, we may select a hardware approach or a software approach:
Hardware Decoupled Mechanical Design: Design the mechanical structure of the wrist to minimize physical coupling between flexion and radial deviation movements.
Software Advanced Control Approach: (i) Implement multi-variable control algorithms to compensate for the coupling effects in real-time; (ii) Use model-based control strategies, such as state-space models or adaptive control, to predict and counteract the coupling effects; and (iii) Use Model-Free Adaptive (MFA) control technology and MIMO MFA controllers, which will be described in this patent application.

To simplify the problem, we can design the robot control system based on 2-input-2-output (2×2) process models for the joints listed in Table 2. A 2×2 process model for a robot joint with 2 degrees of freedom can be represented as follows:

$${G}_{11} ( s ) = \frac{{K}_{11} {e}^{- {τ}_{11} S}}{{T}_{a 11} {s}^{2} + {T}_{b 11} s + 1} , \qquad ( 5 a )$$

$${G}_{21} ( s ) = \frac{{K}_{21} {e}^{- {τ}_{21} S}}{{T}_{c 21} s + 1} , \qquad ( 5 b )$$

$${G}_{12} ( s ) = \frac{{K}_{12} {e}^{- {τ}_{12} S}}{{T}_{c 12} s + 1} , \qquad ( 5 c )$$

$${G}_{22} ( s ) = \frac{{K}_{22} {e}^{- {τ}_{22} S}}{{T}_{a 22} {s}^{2} + {T}_{b 22} s + 1} , \qquad ( 5 d )$$

where G₁₁(s), G₂₁(s), G₁₂(s), and G₂₂(s) are sub-processes of the 2×2 process; s is the Laplace transform operator; K₁₁, K₂₁, K₁₂, and K₂₂ are the static gains for each corresponding sub-process; Tₐ₁₁ and T_{b11} are parameters of the second-order process in (5a); Ta₂₂ and T_{b22} are the parameters of the second-order process in (5d); T_{c21} and T_{c12} are the time constants for the first-order process in (5b) and (5c); and τ₁₁ τ₂₁ τ₁₂ and τ₂₂ are the delay times for each corresponding sub-process. The actual values of these parameters relate to the servo motors, actuators, sensor dynamics, robot mechanics and loads.

Since the coupling between the two movements of a joint is relatively fast in dynamical behavior, the delay time can be set to zero to simplify the design, making it a first-order process. If the coupling is strong, the related static gain is high, and vice versa. In this regard, a 2>2 controller can be designed with decouplers to compensate for the coupling effects.

In a humanoid robot, the motion of two linking joints can also have coupling effects. For instance, the shoulder and elbow are two connected joints. In an arm movement, both joints are moving. When the arm is extended out and the hand is starting to hold a weight, the dynamical behavior of the elbow will affect the shoulder joint. In this regard, to design an effective control system that can deal with motion changes and load variations, a MIMO dynamical model can be very useful.

Modeling the dynamical behavior of multiple linking joints of a humanoid robot can also be done using the same approach. In this case, the 2×2 process model in Equations (5a)-(5d) can be used. Additionally, a 3×3 process model can be developed for this purpose. Due to the length of this document, we will not go into the details.

### E. Dynamical Models and Controllers for Humanoid Robots

FIG. 2 is a block diagram of single-input-single-output (SISO) servo motion control system of a robotic joint, according to an embodiment of this invention. The system (40) comprises Position Controller Cₚ (41), Position Process Pₚ (42), Velocity Controller Cᵥ (43), Velocity Process Pᵥ (44), Torque Controller Cₜ (45), Torque Process Pₜ (46), and signal adders (47), (48), and (49).

This is a single-input-single-output (SISO) double cascade control system with Position to Velocity to Torque loops. The Position Controller Cp (41) is a feedback controller, such as a PID controller or an MFA controller. Its control objective is to produce a control output to minimize the control error, which is the difference between position setpoint trajectory rₚ(t) and measured position yₚ(t) of the robot joint. The control error for the Position Controller Cp (41) is calculated at Adder (47) as follows:

$$e ( t ) = {r}_{p} ( t ) - {y}_{p} ( t ) , \qquad ( 6 )$$

where rₚ(t) is the position setpoint trajectory, and yₚ(t) is the measured position. A measured controlled variable is often called process variable (PV). In this case, it is the measured position. In the Laplace transform s-domain,

$$E ( s ) = Rp ( s ) - Yp ( s ) , \qquad ( 7 )$$

where Rp(S) is the position setpoint trajectory, and Yp(s) is the measured position.

In FIG. 2, it is seen that the output of the Position Controller Cp (41) manipulates the setpoint of the velocity controller Cᵥ (43) in a cascade control scheme. The control error for the Velocity Controller Cᵥ (43) is calculated at Adder (48). The Velocity Controller Cv (43) produces an output to manipulate the setpoint of the Torque Controller Cₜ (45). The control error for the Torque Controller is calculated at Adder (49). The Torque Controller Ct (45) controls the torque of the robot joint.

The robot guidance system provides a position setpoint trajectory to guide the robot joint's movement. The objective of the control system is to ensure that the actual position of the robot joint tracks the setpoint trajectory under varying operating conditions, load changes, and other uncertainties.

The robot guidance system may provide a velocity setpoint trajectory as part of the path planning command. This trajectory represents the desired velocity profile for the robot joint over time. By incorporating this velocity trajectory as a feedforward control signal, the position control system can anticipate the required motion and produce a combined feedback and feedforward control signal, thereby improving control performance, especially during rapid movements or changes in direction.

To achieve smoother and more precise movement, the robot guidance system may also produce an acceleration setpoint trajectory for the robot joint to follow. This acceleration setpoint trajectory can be used as the feedforward control signal for the velocity controller. Its output manipulates the setpoint of the torque control loop. In a robotic servo control system, the inner loop is the torque, current, or power, which corresponds to the acceleration of the position or position angle.

The PID and model-based control methods that can be used in this embodiment are any of the known techniques described in the book, “Modern Robotics: Mechanics, Planning, and Control” by Kevin M. Lynch and Frank C. Park, published by Cambridge University Press in July 2017, wherein the book and its contents are herein expressly incorporated by reference in their entirety.

The Model-Free Adaptive (MFA) control methods and MFA controllers that can be used in this embodiment are any of the known techniques described in Chapter 26, “Model-Free Adaptive Control Software” by George S. Cheng and Steven L. Mulkey, in the book, “Instrument Engineers' Handbook—Process Software and Digital Networks”, edited by Bela Liptak and Halit Eren, published by CRC Press in August 2011, wherein the book and its contents are herein expressly incorporated by reference in their entirety.

All software programs, process models, and control algorithms are executed using computing processing units (CPU). The term “computing processing unit” or “CPU” means a microprocessor, microcontroller, micro-control unit, or any integrated circuit capable of performing computation and executing software programs and control algorithms.

Table 3 lists the PID and MFA controllers that can be used in this embodiment. Detailed descriptions, their parameters, and implementation approaches can be found in the reference books mentioned above.

TABLE 3

| No. | Controller | Description |
|---|---|---|
| 1 | PID | Proportional-Integral-Derivative controller. It |
| | | can be configured as P controller, PI controller, |
| | | PD controller, or PID controller. |
| 2 | SISO | SISO MFA controllers include: Standard MFA |
| | MFA | controller, Nonlinear MFA controller, Nonlinear |
| | | MFA with Feedforward controller, Robust MFA |
| | | controller, and Anti-delay MFA controller. |
| 3 | 2 × | 2 × 2 MFA controllers include: Standard 2 × |
| | 2 MFA | 2 MFA controller, Nonlinear 2 × 2 MFA controller, |
| | | Nonlinear 2 × 2 MFA with Feedforward controller, |
| | | and 2 × 2 Anti-delay MFA controller. |
| 4 | 3 × | 3 × 3 MFA controllers include: Standard 3 × |
| | 3 MFA | 3 MFA controller, Nonlinear 3 × 3 MFA controller, |
| | | Nonlinear 3 × 3 MFA with Feedforward controller, |
| | | and 3 × 3 Anti-delay MFA controller. |
| 5 | Model- | Controllers described in book, “Modern Robotics: |
| | Based | Mechanics, Planning, and Control” by Kevin M. |
| | Controllers | Lynch and Frank C. Park. |

FIG. 3 is a block diagram of 2-input-2-output (2×2) servo motion control system of two coupled variables of a robot joint, according to an embodiment of this invention. The system (50) comprises a 2×2 Position Controller Cₚ (51), a 2×2 Position Process Pₚ (52), 2 Velocity Controllers Cᵥ₁ (53) and Cᵥ₂ (63), 2 Velocity Processes Pᵥ₁ (54) and Pᵥ₂ (64), 2 Torque Controllers Cₜ₁ (55) and Cₜ₂ (65), 2 Torque Processes Pₜ₁ (56) and Pₜ₂ (66), and signal adders (57), (58), (59), (67), (68), and (69). The 2×2 Position Controller Cₚ (51) comprises sub-controllers Cₚ₁ and Cₚ₂. The 2×2 Position Process Pₚ (52) comprises sub-processes Pₚ₁ and Pₚ₂.

This is a 2-input-2-output (2×2) double cascade control system with Position to Velocity to Torque loops. There are two main loops that are relating to two coupled variables of a robot joint such as Pitch and Yaw of a neck joint. This can also apply to two variables or movements of two linking joints such as shoulder and elbow. In this case example, we use Pitch and Yaw of the neck joint as the 2 variables.

The control objective of the 2×2 Position Controller (51) is to minimize the control error of e₁(t) and e₂(t), each of which is the difference between position setpoint trajectory and measured position of the two variables of the robot joint. The control errors for the 2×2 Position Controller (51) are calculated at Adder (57) and (67) as follows:

$${e}_{1} ( t ) = {r}_{p 1} ( t ) - {y}_{p 1} ( t ) , \qquad ( 8 a )$$

$${e}_{2} ( t ) = {r}_{p 2} ( t ) - {y}_{p 2} ( t ) , \qquad ( 8 b )$$

where rₚ₁(t) and rₚ₂(t) are the position setpoint trajectories for Pitch and Yaw, and yₚ₁(t) and yₚ₂(t) are the measured positions for Pitch and Yaw.

For a 2×2 control system, the 2×2 Position Controller (51) to be used in this embodiment can be a 2×2 MFA controller which is able to decouple the interactions between the two coupled variables. Traditionally, two PID controllers can be used to control variable 1 and variable 2 individually. Since these 2 variables are coupled, the control performance of the PID control system may not be satisfactory. For a general-purpose humanoid robot, the control system performance requirements become more stringent. Therefore, a 2×2 MFA controller can be well suited for this application.

In FIG. 3, it is seen that the 2×2 Position Controller (51) includes 2 main controllers Cp₁ and Cp₂. The output of Cₚ₁ manipulates the setpoint of the Velocity Controller Cᵥ₁ (53) and the output of Cₚ₂ manipulates the setpoint of the Velocity Controller Cᵥ₂ (63) in a cascade control scheme. The control error for the Velocity Controller Cᵥ₁ (53) is calculated at Adder (58) and the control error for the Velocity Controller Cᵥ₂ (63) is calculated at Adder (68). The Velocity Controller Cᵥ₁ (53) produces an output to manipulate the setpoint of the Torque Controller Cₜ₁ (55). The Velocity Controller Cᵥ₂ (63) produces an output to manipulate the setpoint of the Torque Controller Cₜ₂ (65). The control error for the Torque Controller Cₜ₁ (55) is calculated at Adder (59). The control error for the Torque Controller Cₜ₂ (65) is calculated at Adder (69). The Torque Controllers Cₜ₁ (55) and Cₜ₂ (65) control the torque of its corresponding variable Pitch and Yaw.

In FIG. 3, the robot guidance system provides a position setpoint trajectory for Pitch and a position setpoint trajectory for Yaw to guide the neck movement. The objective of the 2×2 control system is to ensure that the actual position of Pitch and Yaw tracks the setpoint trajectory under varying operating conditions, load changes, and other uncertainties.

The robot guidance system may provide velocity setpoint trajectories for Pitch and Yaw as part of the path planning command. Feedforward control can be implemented for the 2×2 Position Controller (51) using the velocity setpoint trajectories as shown in FIG. 3. If the robot guidance system provides acceleration setpoint trajectories for Pitch and Yaw as part of the path planning command, feedforward control can be implemented for the Velocity Controller Cᵥ₁ (53) and Velocity Controller Cᵥ₂ (63) as well.

FIG. 4 is a block diagram of 3-input-3-output (3×3) servo motion control system of three coupled variables of a robot joint, according to an embodiment of this invention. The system (70) comprises a 3×3 Position Controller Cₚ (71); a 3×3 Position Process Pₚ (72); 3 Velocity Controllers Cᵥ₁ (73), Cᵥ₂ (83) and Cᵥ₃ (93); 3 Velocity Processes Pᵥ₁ (74), Pᵥ₂ (84) and Pᵥ₃ (94); 3 Torque Controllers Cₜ₁ (75), Cₜ₂ (85) and Cₜ₃ (95); 3 Torque Processes Pₜ₁ (76), Pₜ₂ (86) and Pₜ₃ (96); and signal adders (77), (78), (79), (87), (88), (89), (97), (98) and (99). The 3×3 Position Controller Cₚ (71) comprises sub-controllers Cp1, Cp2, and Cp3. The 3×3 Position Process Pₚ (72) comprises sub-processes Pp1, Pp2, and Pp3.

This is a 3-input-3-output (3×3) double cascade control system with Position to Velocity to Torque loops. There are three main loops that are relating to three coupled variables of a robot joint. For instance, as listed in Table 2, the wrist joint has 3 variables as follows: (i) Flexion and Extension (bending forward and backward), (ii) Radial and Ulnar Deviation (tilting towards the thumb and towards the little finger), and (iii) Pronation and Supination (rotating the hand palm up and palm down). These 3 variables can be coupled causing the control system to be difficult to implement. In this case study, we use Flexion, Radial, and Pronation as three variables.

In FIG. 4, a 3×3 Position Controller (71) is used to control the 3×3 Position Process (72). The control objective of the 3×3 Position Controller (71) is to minimize the control error of e₁(t), e₂(t) and e₃(t), each of which is the difference between position setpoint trajectory and measured position of the three variables of the robot joint. The control errors for the 3×3 Position Controller (71) are calculated at Adder (77), (87) and (97) as follows:

$${e}_{1} ( t ) = {r}_{p 1} ( t ) - {y}_{p 1} ( t ) , \qquad ( 9 a )$$

$${e}_{2} ( t ) = {r}_{p 2} ( t ) - {y}_{p 2} ( t ) , \qquad ( 9 b )$$

$${e}_{3} ( t ) = {r}_{p 3} ( t ) - {y}_{p 3} ( t ) , \qquad ( 9 c )$$

where rₚ₁(t), rₚ₂(t) and rₚ₃(t) are the position setpoint trajectories for Flexion, Radial, and Pronation; and yₚ₁(t), yₚ₂(t) and yₚ₃(t) are the measured positions for Flexion, Radial, and Pronation.

For a 3×3 control system, the 3×3 Position Controller (71) to be used in this embodiment can be a 3×3 MFA controller which is able to decouple the interactions between the three coupled variables. Traditionally, three PID controllers can be used to control variable 1, 2 and 3 individually. Since these 3 variables are coupled, the control performance of the PID control system may not be satisfactory. For a general-purpose humanoid robot, the control system performance requirements for a robot wrist and other joints become more stringent and need to be able to deal with large and sudden load changes. PID controllers are likely unable to effectively control the robot joints with good performance.

Model-based control will be quite complicated with 3 coupled variables and 3 setpoint trajectories. In a state-space representation of a dynamic system, the standard form of the state-space equations is:

$$\dot{x} ( t ) = Ax ( t ) + Bu ( t ) \qquad ( 10 a )$$

$$y ( t ) = Cx ( t ) + Du ( t ) \qquad ( 10 b )$$

where:
x(t) is the state vector representing the state variables of the system.
\dot{x}(t) is the derivative of the state vector or the rate of change of the state vector over time.
u(t) is the input vector representing external inputs or controls applied to the system.
y(t) is the output vector representing the measured outputs of the system.
A is the state matrix that relates the current state to the state derivative.
B is the input matrix that relates the inputs to the state derivative.
C is the output matrix that relates the state to the outputs.
D is the feedforward matrix that relates the inputs directly to the outputs.

There are three states or control loops (Position, Velocity, and Torque) and three variables (Flexion, Radial, and Pronation), the total number of state variable is 3×3=9. Then, A is a 9×9 matrix.

In addition, there are 2 feedforward control signals (setpoint for Velocity, and setpoint for Acceleration). The total number of control output signals is 5. Then, the B matrix is a 9×15 matrix. For the same reasons, C is a 9×9 matrix and D is a 9×15 matrix.

Without going into the details, it can be seen that the control system algorithm to be implemented in computer programs with the state-space based control approach will be very complicated. It is much better to take a simplified and practically useful approach by using a 3×3 MFA controller for the position loop and use single-loop controllers such as MFA or PID to control the velocity and torque loops as described in FIG. 4.

### F. Computer System with Digital Humanoid Robot

FIG. 5 is a block diagram of a computer system that includes a digital humanoid robot with dynamical models as well as a set of single-input-single-output (SISO) controllers and multi-input-multi-output (MIMO) controllers for robot control system design and implementation, according to an embodiment of this invention. The computer system (100) comprises: a main software program running in a computer with CPU and memory (102), a generative Al humanoid robot intelligence engine (104), a robot motion path planner module (106), a digital humanoid robot and joints (108), humanoid robot dynamical models (110), a set of SISO, 2×2, and 3×3 controllers (112), a control system simulation engine (114), a human-machine-interface (HMI) (116), and data storage (118).

As shown in FIG. 5, many of the modules are connected in two ways. The software programs runs on a computer equipped with a CPU, memory, interface I/O, networks, and other peripherals.

The main software (102) interfaces with the generative Al humanoid robot intelligence engine (104) to receive and process high-level commands, enabling users to understand how a humanoid robot can potentially mimic human behavior, respond to natural language commands, and perform human-like tasks.

The robot motion path planner module (106) communicates with the generative Al humanoid robot intelligence engine (104) and generates robot motion commands. It also produces a set of setpoint trajectories for the variables of each joint, which are then sent to the main software program (102). The path planner module (106) ensures that the planned motions are precise and synchronized, allowing the robot to perform complex tasks with fluidity and accuracy.

Through the main software (102), the user can visualize the digital humanoid robot (108) to review the design details and options for each joint. For instance, if a robot is designed with a neck that has 2 degrees of freedom, the software allows the user to select and determine the types of sensors and actuators for the joint. Based on the design selection, the user retrieves the neck design with pitch and yaw motions. This capability enables thorough evaluation and customization of each joint's components, ensuring the robot's movements are precise and suited to its intended tasks.

Based on the design, a set of humanoid robot dynamical models (110) are available for the user to review and select. For instance, the user may choose the simplified model option with a 2×2 process for Pitch and Yaw of the neck. The user can then run open-loop step tests using the Control System Simulation Engine (114) and view the resulting data and trends on the Human-Machine Interface (HMI) (116). The parameters of the 2×2 process, including static gain, time constant, delay time, and coupling gains, can be intentionally changed to simulate the process's varying ranges. This functionality allows the user to analyze the dynamic behavior and responses of the robot joints, fine-tune the robot joint design parameters, and test controllability and stability under various operating conditions. The comprehensive simulation efforts ensure that the movements of the robot are optimized and can deal with potential disturbances and changes in the environment.

The user can then select 2×2 and SISO controllers for the position, velocity, and torque control loops for each variable from the Controller Set (112). The selected controllers and dynamical models can be easily configured to run closed-loop control simulations in the Control System Simulation Engine (114). The user can run each control loop in manual mode or auto mode, switching back and forth, and adjust controller parameters until performance is satisfactory. A cascade control system is typically launched from the inside out. This means the user will run the torque control loops first, followed by the velocity loop, with the position loop being the last to run. This sequential approach ensures that each control loop is stable and tuned correctly before integrating with the subsequent loop, leading to a robust and well-coordinated control system for the humanoid robot.

Then, feedforward control is added using the setpoint trajectories from the Robot Motion Path Planner module (106). The feedforward controller parameters, such as the feedforward gain and time constants, are adjusted to ensure the feedback and feedforward controllers are integrated seamlessly. The final motion performance of the joint can be observed and tracked on the Digital Humanoid Robot and Joints (108) module with 3D graphics and videos. Smooth motion should be evident. If not, the user may revisit the Robot Motion Path Planner as well as the Generative Al Engine for more detailed design reviews to perfect the robot design. This iterative process ensures that the humanoid robot operates with the desired precision and fluidity.

Finally, all the information is saved in Data Storage (118) for future retrieval and analysis. This includes all the design configurations, control parameters, simulation results, and performance data. By storing this data, users can easily access past configurations, compare different design iterations, and refine the robot control systems over time. This comprehensive data management ensures that valuable insights and design optimizations are preserved, facilitating continuous improvement and innovation in humanoid robot development.

FIG. 6 is a perspective view of a computer HMI screen showing a Humanoid Robot Joint Process Model and Controller Selection Menu, according to an embodiment of this invention. It displays an image of a humanoid robot (122), a list of robot joints and process models (124), and a list of robot joint controllers (126). Using the mouse, the user can select a joint from the digital humanoid robot (122), such as the neck. The user can then select a Neck 2×2 Process (127) and a Neck 2×2 Controller (128) as part of the design process. This interactive interface enables users to easily navigate through the various options for modeling and controlling each joint, facilitating a streamlined and efficient design workflow.

FIG. 7 is a perspective view of a computer HMI screen showing a Humanoid Robot—Head & Neck Pitch and Yaw Motion—2×2 Control System menu, according to an embodiment of this invention. It displays an image of a humanoid robot head and neck (132), a selected 2×2 Neck Process (134), a selected 2×2 Neck Controller (136), and a block diagram of a 2-input-2-output (2×2) servo motion control system for the two coupled variables of the neck joint (138). The 2×2 servo motion control system is designed to control the Pitch and Yaw of the neck, as described in FIG. 3.

In FIG. 7, it shows that the user selected a 2×2 second-order coupled process for the Neck joint. A 2×2 MFA Feedforward controller is also selected. This interface allows users to visualize and configure the control system for the neck's Pitch and Yaw motions, ensuring precise and coordinated movements.

FIG. 8 is a perspective view of a computer HMI screen showing MFA and PID control simulation for nonlinear processes, according to an embodiment of this invention.

The screen displays a faceplate (142) of an MFA controller showing its Setpoint (SP), Process Variable (PV), and Controller Output (OP) in numerical values and graphical bars. The Setpoint (144) starts at 50, changes to 60, then to 20, and eventually to 95. It is observed that the MFA controller Output (146) changes immediately in response to Setpoint changes. Its control objective is to force the Process Variable (148) to track the Setpoint (144) under setpoint changes, process dynamical changes, and other uncertainties.

The screen also displays a faceplate (152) of a PID controller showing its Setpoint (SP), Process Variable (PV), and Controller Output (OP) in numerical values and graphical bars. The Setpoint (154) starts at 50, changes to 60, then to 20, and eventually to 95, just like the MFA controller. It is observed that the PID controller Output (156) changes immediately in response to Setpoint changes. Its control objective is to force the Process Variable (158) to track the Setpoint (154) under setpoint changes, process dynamical changes, and other uncertainties.

The MFA and PID controllers are controlling two identical nonlinear processes with very large static gain changes. Each nonlinear process model is a First-Order-Plus-Delay model as represented in Equation (1) with varying static gain, time constant, and delay time. The static gain may change as much as 100 times.

It is seen that the PID controller causes the Process Variable (158) to oscillate when Setpoint (154) equals 20. In this operating condition, the nonlinear curve is concave, and the process static gain is quite large. During the same condition, the MFA controller is able to deal with the nonlinear behavior of the process and keep the Process Variable (148) tracking the Setpoint (144).

It is observed that the PID controller causes the Process Variable (158) to oscillate when the Setpoint (154) is 20. In this operating condition, the nonlinear curve is concave, and the process static gain is quite large. During the same condition, the MFA controller can effectively deal with the nonlinear behavior of the process, keeping the Process Variable (148) tracking the Setpoint (144).

During this simulation, the nonlinear process model is suddenly changed from a concave to a convex nonlinear curve without re-tuning the controller parameters. It is observed that the controller Outputs (146) and (156) change significantly to keep the Process Variables (148) and (158) tracking their respective setpoints (144) and (154). Then, when the Setpoints (144) and (154) are increased to 95, the MFA control trend continues to show good performance, while the PID control trend exhibits significant oscillation.

FIG. 8 demonstrates how an MFA controller can provide consistent control performance under process variations and load changes, while a PID controller must be tuned for a specific operating condition and cannot maintain consistent performance under varying conditions. It can be concluded that the MFA controller has a wider robust range than the PID controller. MFA is well-suited for motion control of joints in humanoid robots.

Users can observe real-time control performance, adjust controller parameters, and fine-tune the system to achieve optimal control outcomes. The computer system provides a hands-on experience for designing, testing, and validating robot control systems for humanoid robots.

FIG. 9 is a computer screen showing the real implementation of a 2×2 MFA control system for controlling a 2×2 robot joint in the LabVIEW environment, according to an embodiment of this invention.

LabVIEW is a testing, simulation, and control software developed by National Instruments. It provides a graphical programming environment used extensively for data acquisition, instrumentation, monitoring, and industrial automation. As a case example, the robot dynamical models and MFA controllers are implemented as LabVIEW virtual instruments (VI). This approach allows the disclosed computer system to be implemented within the LabVIEW environment, enabling seamless integration with the LabVIEW Robot Module, which includes robot path planner functions. This integration facilitates the design, testing, and implementation of sophisticated control systems for humanoid robots, leveraging various capabilities of the LabVIEW software. Please note that the computer system disclosed in this patent can also be implemented without using LabVIEW.

Once the robot control system design and testing are complete, the same PID or MFA controllers can be implemented in various high-speed control devices and microprocessor CPUs to control a real robot. By working with Generative AI and other software tools, the disclosed computer system enables robot control system design, testing, validation, and implementation in one step, significantly reducing time to market for robotics companies. The system also allows for easy control system upgrades to support ongoing efforts in developing new robots with new designs, types, actuators, sensors, and materials. This flexibility ensures that the control systems remain adaptable and scalable to accommodate advancements in robotics technology.

### G. Conclusion

A general-purpose humanoid robot has many joints, each of which may have 3 degrees of freedom. The robot needs to perform undefined tasks in an unknown environment. Generative Artificial Intelligence (Gen-AI) tools and trained large-language models have the potential to develop a robot guidance system to navigate a humanoid robot to walk and perform certain tasks. However, the robot control system remains the most challenging obstacle in developing general-purpose humanoid robots. Since it must be a deterministic system with 100% repeatability, LLM-based generative AI, which is a statistical-based approach, is not suitable. There is an urgent need for tools in robot control system design and implementation.

The motivation to develop a computer system that includes a digital humanoid robot with dynamical models and a set of controllers for robot control system design and implementation fits the mega-trend of the 4th Industrial Revolution, where everything will be smart. In the not-too-distant future, humanoid robots and robotic creatures will be deployed on a large scale to enhance various sectors, including industrial automation, environmental monitoring, disaster response, wildlife conservation, agriculture, healthcare, and public safety. These advancements will lead to more efficient resource management, quicker emergency responses, better protection of natural habitats, increased industrial and agricultural yields, and improved safety and security in public spaces, profoundly benefiting our society.

The applicant of this patent has many years of experience in technology innovation in industrial automation, renewable energy, and artificial intelligence. Our goal is to contribute to the exciting technology transformation enabled by generative artificial intelligence in various applications that can make a significant impact on our society and the world.

1. A system for humanoid robot control system design, comprising:
a) a computer with a processor and a computer readable storage medium coupled to the processor; and
b) a software program to be executed by the processor and stored on the computer readable storage medium, said software program further comprising:
i) a plurality of dynamical models represented by Laplace transfer functions for robot joints;
ii) a plurality of controllers;
iii) a human-machine-interface (HMI) mechanism; and
iv) a control system simulation mechanism comprising a user selected dynamical model from the plurality of dynamic models and a controller from the plurality of controllers arranged to perform control simulations.

2. The system of claim 1, further comprising an interface mechanism to a robot motion path planner mechanism adapted to receive setpoint trajectories for motion control of robot joints.

3. The system of claim 1, further comprising an interface mechanism to a generative artificial intelligence (AI) engine for humanoid robots adapted to receive high-level commands, enabling users to understand how a humanoid robot can mimic human behavior and perform human-like tasks.

4. The system of claim 1, wherein the human-machine interface (HMI) mechanism when executed by the processor comprises:
a) a software window showing a humanoid robot image or a video; and
b) a list of dynamical models indicated by a name of each joint of the robot.

5. The system of claim 1, wherein the human-machine-interface (HMI) mechanism when executed by the processor comprises:
a) a software window displaying a control system diagram; and
b) a list of controllers identified by their names.

6. The system of claim 1, wherein the human-machine-interface (HMI) mechanism is programmed to allow the user to select a dynamical model from the plurality of dynamic models to run open-loop simulations.

7. The system of claim 1, wherein the human-machine-interface (HMI) mechanism is programmed to allow the user to select a dynamical model from the plurality of dynamic models and a controller from the plurality of controllers to run closed-loop control simulations.

8. The system of claim 1, wherein the dynamical models comprise single-input-single-output (SISO), 2-input-2-output (2×2), and 3-input-3-output (3×3) process models to represent the robot joints.

9. The system of claim 8, wherein the single-input-single-output (SISO) dynamical model is a First-Order-Plus-Delay (FOPD) model in Laplace transfer function as follows:
$${G}_{p} ( s ) = \frac{K {e}^{- τ S}}{{T}_{c} s + 1} , \qquad ( 11 )$$
where Gp(S) is the transfer function of a dynamical process, K is the static gain, T_{c} is the time constant, and τ is the delay time.

10. The system of claim 8, wherein the 2-input-2-output (2×2) dynamical model in Laplace transfer function is as follows:
$${G}_{11} ( s ) = \frac{{K}_{11} {e}^{- {τ}_{11} S}}{{T}_{a 11} {s}^{2} + {T}_{b 11} s + 1} , \qquad ( 12 a )$$
$${G}_{21} ( s ) = \frac{{K}_{21} {e}^{- {τ}_{21} S}}{{T}_{c 21} s + 1} , \qquad ( 12 b )$$
$${G}_{12} ( s ) = \frac{{K}_{12} {e}^{- {τ}_{12} S}}{{T}_{c 12} s + 1} , \qquad ( 12 c )$$
$${G}_{22} ( s ) = \frac{{K}_{22} {e}^{- {τ}_{22} S}}{{T}_{a 22} {s}^{2} + {T}_{b 22} s + 1} , \qquad ( 12 d )$$
where G₁₁(s), G₂₁(s), G₁₂(s), and G₂₂(s) are sub-processes of the 2×2 process; s is the Laplace transform operator; K₁₁, K₂₁, K₁₂, and K₂₂ are the static gains for each corresponding sub-process; Tₐ₁₁ and T_{b11} are parameters of the second-order process in (12a); Tₐ₂₂ and T_{b22} are the parameters of the second-order process in (12d); T_{c21} and T_{c12} are the time constants for the first-order process in (12b) and (12c); and τ₁₁ τ₂₁ τ₁₂ and τ₂₂ are the delay times for each corresponding sub-process.

11. The system of claim 1, wherein the plurality of controllers comprise: a single-input-single-output (SISO) Proportional-Integral-Derivative (PID) controller; a single-input-single-output (SISO) Model-Free Adaptive (MFA) controller; a 2-input-2-output (2×2) Model-Free Adaptive (MFA) controller; and a 3-input-3-output (3×3) Model-Free Adaptive (MFA) controller.

12. A method for humanoid robot control system design comprising the steps of:
a) inputting a selection of a robot joint;
b) inputting a selection of a dynamical model represented by Laplace transfer functions for the joint;
c) inputting a selection of a controller;
d) running control simulations with the selected dynamical model and controller;
e) analyzing the control results and adjusting model parameters and controller parameters; and
f) determining the final design of a control system for the joint.

13. The method for humanoid robot control system design of claim 12, further comprising:
a) receiving setpoint trajectory information for robot joints from a robot path planner mechanism; and
b) performing control simulations with the setpoint trajectories.

14. The method for humanoid robot control system design of claim 12, further comprising performing feedforward control using the setpoint trajectories.

15. The method for humanoid robot control system design of claim 12, further comprising receiving high-level commands from a generative artificial intelligence (AI) engine for humanoid robots.

16. A non-transitory computer software mechanism for humanoid robot control system design, comprising:
a) a plurality of dynamical models represented by Laplace transfer functions for robot joints;
b) a plurality of controllers;
c) a human-machine-interface (HMI) mechanism, and
d) a control system simulation mechanism comprising a user selected dynamical model from the plurality of dynamic models and a controller from the plurality of controllers arranged to perform control simulations.

17. The non-transitory computer software mechanism of claim 16, further comprising an interface mechanism to a robot motion path planner mechanism adapted to receive setpoint trajectories for motion control of robot joints.

18. The non-transitory computer software mechanism of claim 16, wherein the human-machine-interface (HMI) mechanism is programmed to allow the user to select a dynamical model to run open-loop simulations.

19. The non-transitory computer software mechanism of claim 16, wherein the human-machine-interface (HMI) mechanism is programmed to allow the user to select a dynamical model and a controller to run closed-loop control simulations.

20. The non-transitory computer software mechanism of claim 16, wherein the dynamical models comprise single-input-single-output (SISO), 2-input-2-output (2×2), and 3-input-3-output (3×3) process models to represent the robot joints.
